(19) United States
(12) Patent Application Publication
(10) Pub. No.: US 2016/0219832 A1
(43) Pub. Date: Aug. 4, 2016

(54) Pet Food Bowl

(71) Applicant: Stephanie Langston, Rohnert Park, CA (US)

(72) Inventor: Stephanie Langston, Rohnert Park, CA (US)

(21) Appl. No.: 14/714,454

(22) Filed: May 18, 2015

Related U.S. Application Data
(60) Provisional application No. 62/109,795, filed on Jan. 30, 2015.

(51) Int. Cl. A01K 5/01

(52) U.S. Cl. CPC A01K 5/0142

(57) ABSTRACT

A pet food bowl for preventing insects from gaining access to the pet's food. The pet food bowl includes a bowl having a base and upstanding sidewalls defining an interior volume in which food or water can be positioned. The bowl is removably securable to a dish having a base, an exterior sidewall around the perimeter thereof, and an interior sidewall that defines a central interior volume in which the bowl can be positioned. Liquid can be used to fill the space between the exterior and interior sidewall, such that the central interior volume is surrounded by liquid. The height of the interior sidewall is greater than the height of the exterior sidewalls of the dish, so as to prevent wliquidater from entering the bowl. Thus, crawling insects are prevented from gaining access to the food or liquid within the bowl due to the liquid in the dish.

### CROSS REFERENCE TO RELATED APPLICATION

This application claims the benefit of U.S. Provisional Application No. 62/109,795 filed on Jan. 30, 2015. The above identified patent application is herein incorporated by reference in its entirety to provide continuity of disclosure.

### BACKGROUND OF THE INVENTION

### Field of the Invention

The present invention relates to bowls. More specifically, the present invention provides a pet food bowl comprising means for preventing insects from gaining access to the food within the bowl. The pet food bowl comprises a bowl in which food can be positioned, wherein the bowl is removably positioned on a dish. The dish can be filled with liquid such that the liquid surrounds the bowl, forming a moat. In this way, crawling insects are prevented from gaining access to the food within the bowl due to their inability to traverse the water within the dish.

Many pet owners position their pet's food bowl and water bowls outside of the home on a patio, porch, or other similar area. This allows a pet that spends time outside to have access to food and water without having to enter the pet owner's home. However, pet food can attract various types of insects, and insects may gain access to the pet's food. Crawling insects such as ants or beetles may be attracted to the food and can simply crawl into the pet's food bowl. If the insects are not detected and removed, additional insects may crawl into the pet's food bowl.

Once the insects are within the food bowl, the insects can begin to consume the pet food, and may contaminate the pet food as many insects carry germs and bacteria. Additionally, the insects may produce waste products that further contaminate the pet's food bowl. A pet may consume the insects while eating the pet food which can be harmful to the pet. Thus, a pet food bowl that deters or prevents insects from accessing the food therein is desired.

Devices have been disclosed in the prior art that relate to pet food bowls. These include devices that have been patented and published in patent application publications. Some devices provide food bowls having channels or troughs in which water can be placed to prevent insects from gaining access to the pet food, such as U.S. Pat. No. 4,981,108, U.S. Pat. No. 2,191,811, U.S. Pat. No. 2,584,301, and U.S. Pat. No. 4,357,905. Other patents, such as U.S. Pat. No. 4,803,954, provide pet food bowls with means for deterring insects from entering the same.

These prior art devices have several known drawbacks. The devices in the prior art provide channels in which water can be positioned, but fail to provide a bowl removably positionable on a dish, wherein the dish is configured to be filled with water such that the bowl within the dish is surrounded by water. The ability to separate the bowl and dish allows for ease of cleaning and allows the bowl to be removed for filling, emptying, or cleaning without disturbing the liquid within the dish.

In light of the devices disclosed in the prior art, it is submitted that the present invention substantially diverges in design elements from the prior art and consequently it is clear that there is a need in the art for an improvement to existing pet food bowl devices. In this regard the instant invention substantially fulfills these needs.

### SUMMARY OF THE INVENTION

In view of the foregoing disadvantages inherent in the known types of pet food bowls now present in the prior art, the present invention provides a new pet food bowl wherein the same can be utilized for providing convenience for the user when preventing crawling insects, such as ants and beetles, from gaining access to food within a pet bowl.

It is therefore an object of the present invention to provide a new and improved pet food bowl device that has all of the advantages of the prior art and none of the disadvantages.

It is another object of the present invention to provide a pet food bowl comprising a bowl and a dish, wherein the bowl can be removably positioned within said dish, and wherein the dish can be filled with water such that the bowl and the food therein are surrounded by water held by the dish.

Another object of the present invention is to provide a pet food bowl comprising a bowl removably positionable a dish, wherein the dish includes an interior wall defining a central interior volume adapted to receive the bowl therein.

Yet another object of the present invention is to provide a pet food bowl comprising a bowl positioned within a dish, wherein the diameter of the bowl is less than that of the dish, and wherein the height of the sidewalls of the bowl is greater than the height of the exterior sidewall of the dish.

Another object of the present invention is to provide a pet food bowl that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the pet food bowl.

FIG. 2 shows an overhead view of the pet food bowl.

FIG. 3 shows a perspective view of the bowl as positioned for insertion into the dish of the pet food bowl.

FIG. 4 shows a cross-sectional side view of the bowl as positioned for insertion into the dish of the pet food bowl.

### DETAILED DESCRIPTION OF THE INVENTION

Reference is made herein to the attached drawings. Like reference numerals are used throughout the drawings to depict like or similar elements of the pet food bowl. For the purposes of presenting a brief and clear description of the present invention, the preferred embodiment will be discussed as used for preventing crawling insects from gaining access to the food within a pet's bowl. The figures are intended for representative purposes only and should not be considered to be limiting in any respect.

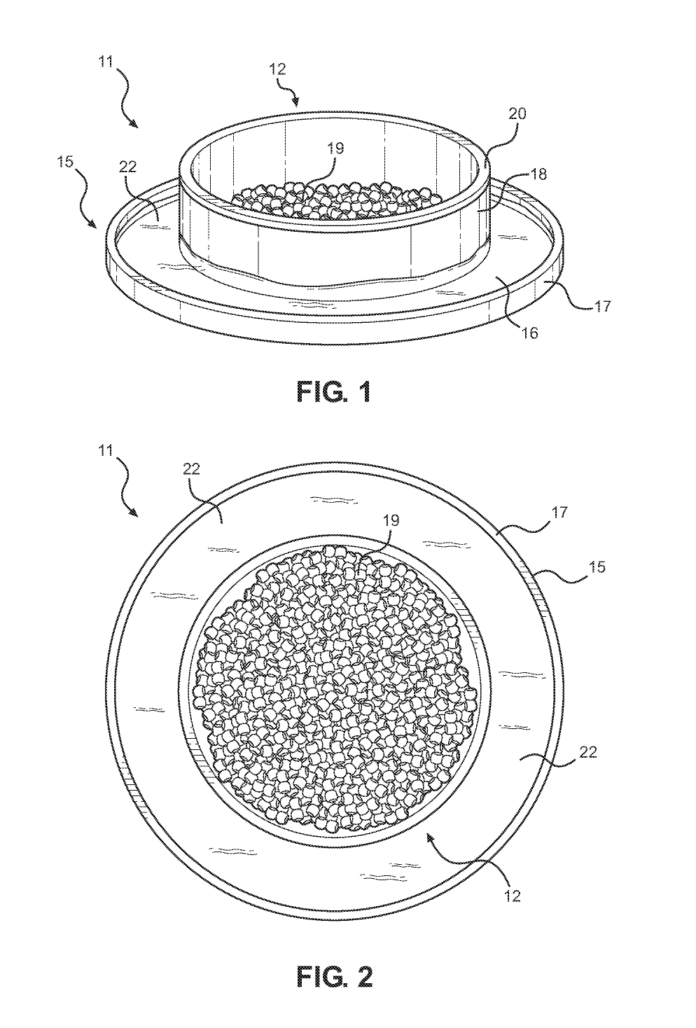

Referring now to FIGS. 1 and 2, there is shown a perspective view of the pet food bowl and an overhead view of the pet food bowl. The pet food bowl 11 comprises a bowl 12 positioned within a dish 15. The bowl 12 comprises a base, upstanding sidewalls, and an open upper end, defining an interior volume 19 in which food or water can be positioned. The upper end of the sidewalls further includes a lip 20 that is adapted to rest on an interior wall 18 of the dish 15. In the illustrated embodiment, the bowl 12 comprises a circular configuration. However, in alternate embodiments, the bowl 12 comprises alternate configurations, such as a square or rectangular shape.

The dish 15 comprises a base 16, an exterior upstanding sidewall 17 about the perimeter thereof, and an interior sidewall 18 defining a central interior volume adapted to removably receive the bowl 12 therein. The exterior sidewall 17 and interior sidewall 18 are separated by a space so as to define a channel 22 in which liquid can be positioned so as to surround the central interior volume. Thus, the liquid serves as a moat, preventing crawling insects from entering the pet food bowl. The dish 15 preferably comprises a similar configuration as the bowl 12. For example, in embodiments wherein the bowl 12 is circular, the dish 15 is also circular. The dish 15 comprises a larger diameter than the bowl 12, such that the bowl 12 can fit within the dish 15.

Further, the height of the interior sidewall 18 is preferably greater than the height of the exterior sidewall 17 of the dish 15. In this way, the liquid within the dish 15 is prevented from accidentally spilling or splashing into the food within the bowl 12. If the interior sidewall 18 was too low, the liquid within the dish 15 may enter the central interior volume in which the bowl 12 and pet food are positioned. Additionally, the liquid within the dish 15 need not be of any specific depth, as the depth of the liquid does not impact an insect's ability to cross the dish 15 and enter the bowl 12, as long as the depth is such that an insect cannot walk along the base 16 of the dish 15.

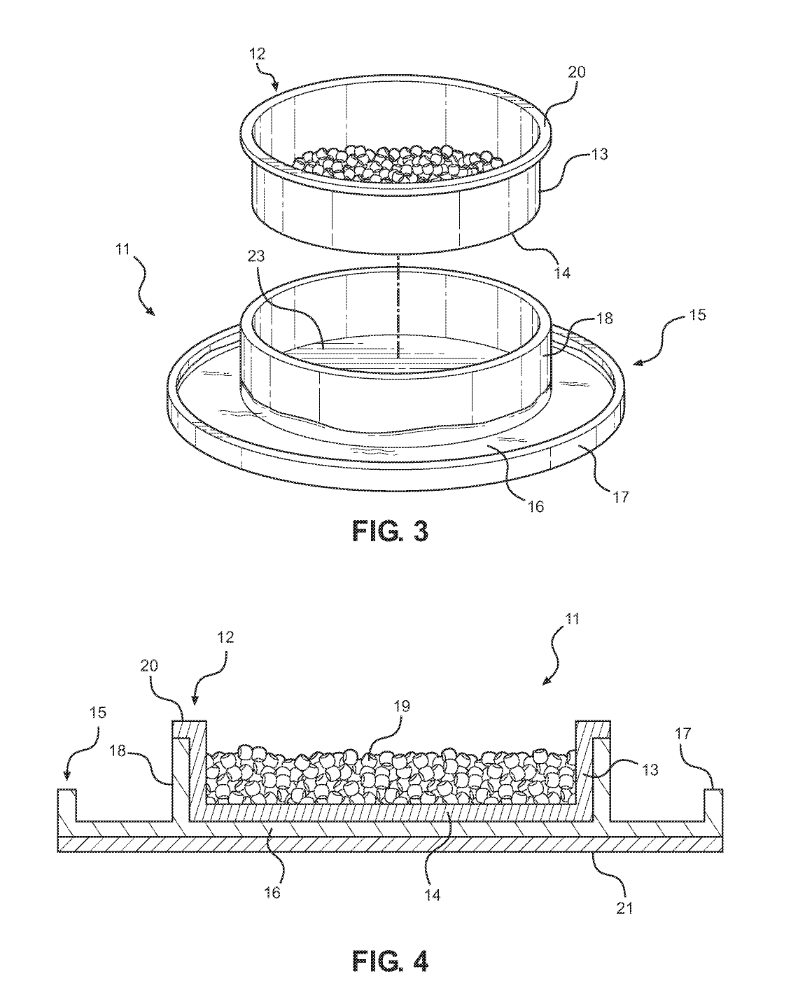

Referring now to FIGS. 3 and 4, there is shown a perspective view and a side view of the bowl as positioned for insertion into the dish of the pet food bowl. Preferably, the bowl 12 is removably positionable within the central interior volume of the dish 15. In this way, the bowl 12 will remain in a desired position relative to the dish 15 when inserted therein. Further, the ability to separate the bowl 12 from the dish 15 facilitates the process of cleaning the pet food bowl 11 and filling the bowl 12.

The interior sidewall 18 of the dish 15 preferably includes a circular configuration. Further, the interior sidewall 18 and the exterior sidewall 17 are preferably concentric circles. The interior sidewall 18 defines a central interior volume 23 in which the food bowl 12 can be positioned. The food bowl 12 is sized to fit within the central interior volume 23 and is adapted to fit snugly therein. The base 14 of the bowl rests flush against the base of the dish 12, and the sidewalls 13 of the bowl 12 preferably contact the interior surface of the interior wall 18 of the dish 12. The upper end of the walls 13 of the bowl 12 includes a lip 20 thereon. The lip 20 is adapted to rest on the upper edge of the interior sidewall 18 of the dish 15, and the lip 20 allows the user to more easily grasp, hold, and remove the bowl 12 as needed.

The dish 15 further comprises a non-slip material 21 disposed on the underside thereof. The non-slip material may be a high friction coating, or may include a rubber or silicone pad, among others. In this way, when the dish 15 is positioned on the ground, the dish will not easily slide or move. This helps to prevent the pet food bowl 11 from being moved out of a desired position, and helps to prevent the food or water therein from spilling.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. I claim:

1) A pet food bowl, comprising:
a bowl having a base, sidewalls, and an open upper end, defining an interior volume;
a dish having a base, an exterior sidewall about the perimeter of said base, and an interior sidewall extending upwardly from said base and defining a central interior volume;
wherein said bowl is removably positionable within said central interior volume;
wherein said dish is adapted to be filled with liquid such that said bowl is surrounded by said liquid when inserted within said central interior volume.

2) The pet food bowl of claim 1, wherein said bowl and said dish are substantially circular in configuration.

3) The pet food bowl of claim 1, wherein a height of said interior sidewall is greater than the height of said exterior sidewall.

4) The pet food bowl of claim 1, wherein a diameter of said bowl is less than a diameter of said dish.

5) The pet food bowl of claim 1, wherein said bowl is removably securable to said dish.

6) The pet food bowl of claim 1, wherein an underside of said base of said dish comprises a non-slip material.
